(19) United States
(12) Patent Application Publication
(10) Pub. No.: US 2011/0141924 A1
(43) Pub. Date: Jun. 16, 2011

(54) System and Method for Filtering High Priority Signaling and Data for Fixed and Mobile Networks

(75) Inventors: Robert W. Froehlich, McKinney, TX (US); Seshu Dommaraju, Plano, TX (US)

(73) Assignee: Tektronix Inc., Beaverton, OR (US)

(21) Appl. No.: 12/639,213

(22) Filed: Dec. 16, 2009

(51) Int. Cl. H04L 12/26

(52) U.S. Cl. 370/252

(57) ABSTRACT

A system and method for monitoring IP flows in a telecommunications network is disclosed. Data packets are captured from the links in the telecommunications network via a plurality of monitoring probes. The data packets are filtered, using an interface processor, to classify the data packets by subscriber identification and link identification to create classified packets. The classified packets are filtered by application, using a packet processor, to create call session records. A subscriber record is created, using a subscriber session processor, the subscriber record binding subscriber information from the call session records, the subscriber record comprising a plurality of fields including a high value tag. One or more of the network nodes are controlled using a configuration manager according to policy rules that correspond to the high value tag.

### TECHNICAL FIELD

Embodiments are directed, in general, to identifying high value subscribers in a telecommunications network and, more specifically, to filtering out high priority signaling and data for high value accounts, groups or regions from general public services traffic in the networks.

### BACKGROUND

The number of subscribers using telecommunications networks and the number of services available across such networks has created an enormous volume of data traffic. Additionally, data rates for bearer and data services on fixed and mobile networks are growing geometrically. Widely used services such as Triple Play (i.e. provisioning high-speed Internet access, television, and telephone services over a single broadband connection), streaming video, High Speed Downlink Packet Access (HSDPA), and High Speed Uplink Packet Access (HSUPA) use enormous bandwidth. Real time and historical monitoring of traditional bearer and services is becoming cost prohibitive due to the volume of traffic on the networks. Overall, network operators' capital expenditure (CAPEX) is decreasing when the operators migrate to next-generation IP networks, which limits the monitoring equipment deployed on networks.

As a result, passive network monitoring systems cannot efficiently capture and analyze all of the network data associated with public services such as web browsing (Hypertext Transfer Protocol—HTTP), e-mail (Simple Mail Transfer Protocol—SMTP, Post Office Protocol 3—POP3, Internet Message Access Protocol—IMAP), and video or audio streaming (Real-time Transport Protocol—RTP). Monitoring systems must evolve from capturing all public service data and analyzing that data in detail, because the volume of information makes it difficult to identify and troubleshoot network problems.

### SUMMARY

The present invention provides a system and method for gleaning data from the “noise” (i.e. high volume of data) in fixed and wireless networks by focusing on high value subscribers. The present invention allows the network monitoring system to capture data from fixed and mobile networks and to instantaneously bind data flows into particular subscriber views.

Embodiments of the network monitoring system described herein define an architectural framework for filtering high priority signaling and data from fixed and mobile networks. The monitoring solution can be designed so that the systems can handle high priority signaling and data for subscribers in High Value Accounts (HVA) or High Value Groups (HVG) or High Value Regions (HVR) whiling provide a broad indication of the quality of service for public subscribers.

An exemplary embodiment of the present invention provides cost-effective monitoring of HVA/HVG/HVR with extensive Quality of Service (QoS) information compared to typical flow based analysis.

Embodiments of the present invention provide a system and method for binding data packets with a super subscriber record or with subscriber permanent identities. Packets may also be bound to an HVA/HVG/HVR tag or to a high revenue location tag, such as, for example, a femtocell ID.

Embodiments of the present invention further provide filtering packet data based on a selected HVA/HVG/HVR.

Subscriber information is tracked, correlated, and bound across multiple-interfaces and multiple-probes using fixed and mobile data service hosted and ISP service analysis. A super subscriber record is created that either references or contains information about related subscriber information collected from multiple interfaces, multiple probes, and Operation Support Systems (OSS).

### BRIEF DESCRIPTION OF THE DRAWINGS

Having thus described the system and method in general terms, reference will now be made to the accompanying drawings, which are not necessarily drawn to scale, and wherein:

FIG. 1 illustrates a high level mobile network;

FIG. 2 illustrates a high level fixed network overview;

FIG. 3 illustrates data flow in one embodiment of an existing network monitoring framework; and

FIG. 4 illustrates one embodiment of a high level framework for processing high bandwidth signaling and data.

### DETAILED DESCRIPTION

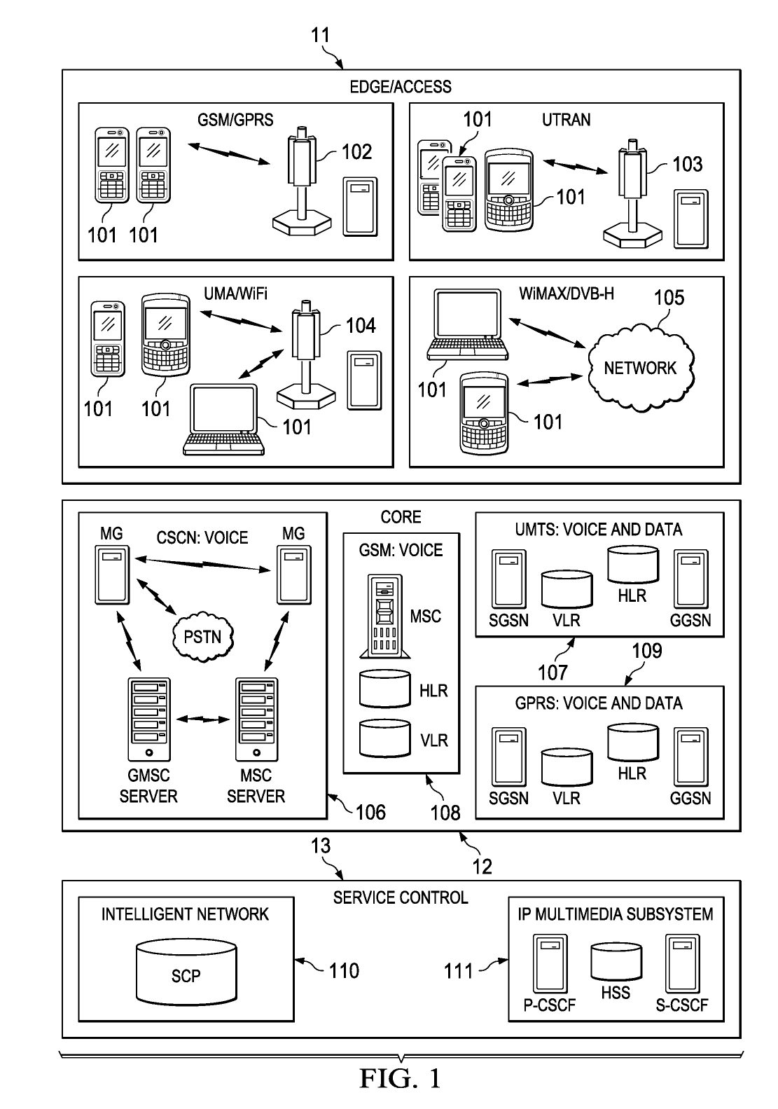

FIG. 1 illustrates a high level mobile network overview showing edge/access devices 11 in which subscribers 101 communicate with different network devices, such as base station 102 in a GSM/GPRS network, NodeB 103 in a UTRAN network, access point 104 in a WiFi (IEEE 802.11) or Unlicensed Mobile Access (UMA) network, or access network 105 in a WiMax (IEEE 802.16) or Digital Video Broadcasting—Handheld (DVB-H) network. Subscribers 101 access core network 12 via the edge/access devices 11. Depending upon the access network and requested services or applications, data from subscribers 101 may be transmitted to Circuit Switched Cellular Network (CSCN) network 106, UMTS network 107, GSM network 108, or GPRS network 109. Core networks 12 may be coupled to service control networks 13, such as Intelligent Network (IN) 110 which provides value-added services, for example. Core networks 12 may be coupled to IP Multimedia Subsystem (IMS) 111 components, such as a Proxy Call Session Control Function (P-CSCF), Serving Call Session Control Function (S-CSCF), or Home Subscriber Server (HSS).

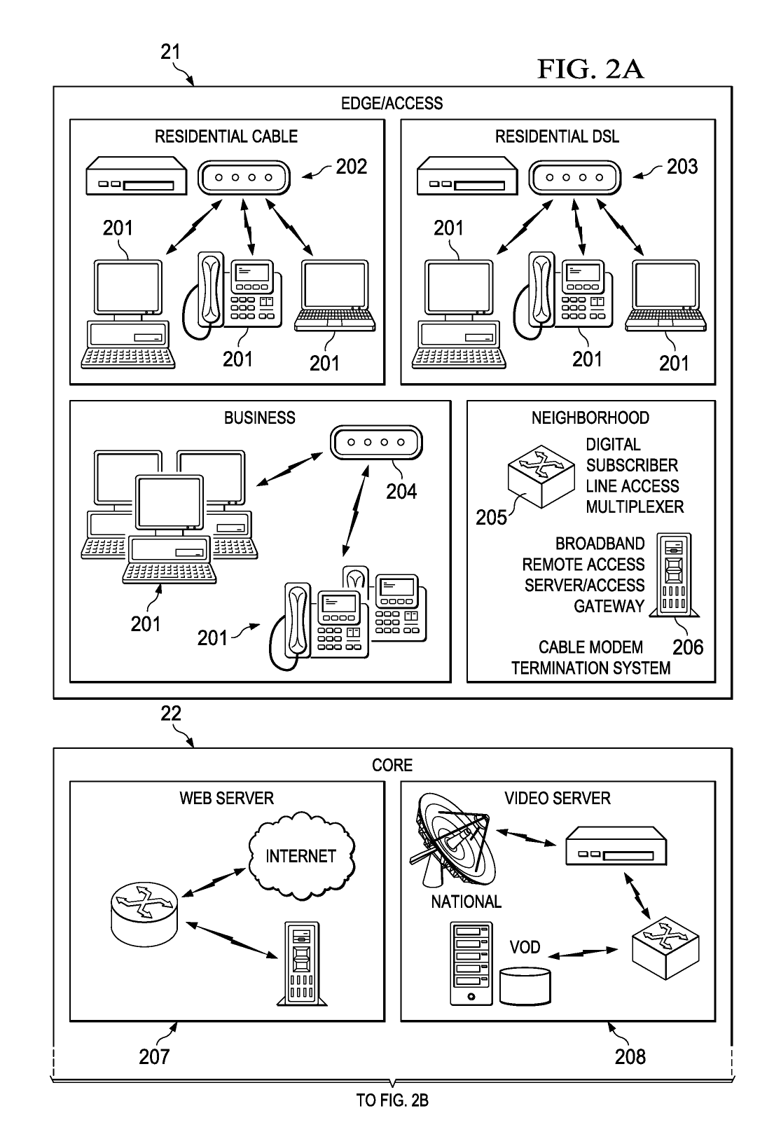

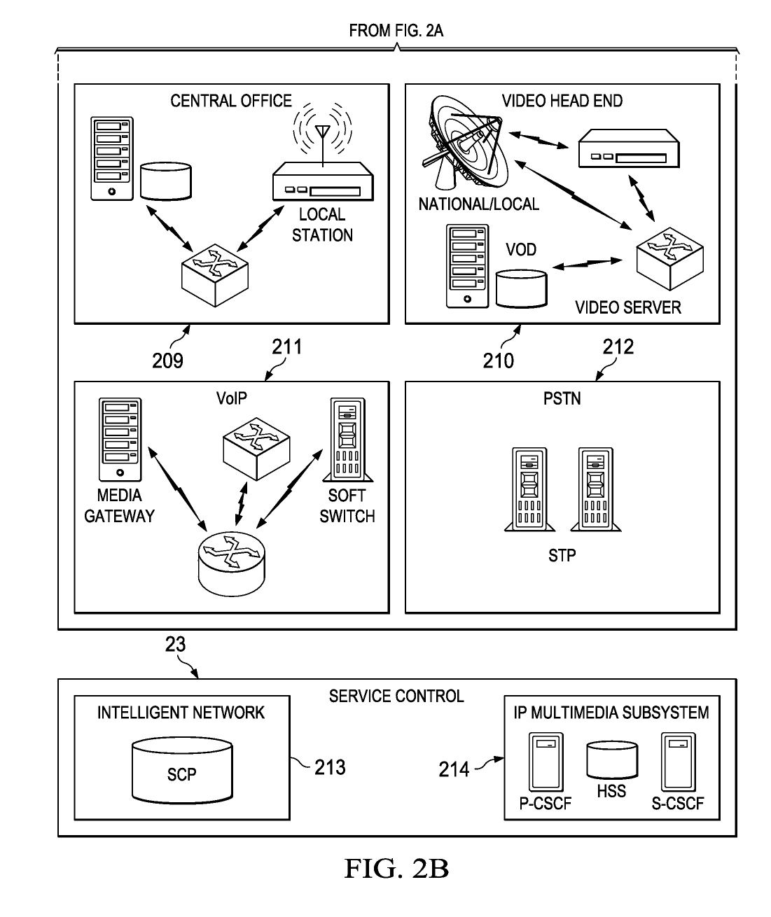

FIG. 2 illustrates a high level fixed network overview showing edge/access devices 21 in which subscribers 201 communicate with different network devices depending upon their respective service providers and configuration. Access devices include, for example, modems 202-204 in residential cable or residential or business DSL networks or Digital Subscriber Line Access Multiplexer (DSLAM) 205 or Broadband Remote Access Server (BRAS) 206 in a Cable Modem Termination System (CMTS). Edge/access devices 21 are coupled to core networks 22, such as web server 207, video server 208, central office 209, video head end 210, VoIP gateway 211, or PSTN 212. Core networks 22 may be coupled to service control networks 23, such as IN 213 and IMS 214.

The availability of data flows in fixed and mobile networks varies by network. The present invention provides a method for identifying and capturing the most important data in the networks. Fixed and mobile networks are converging as they use more packetized data and share the same access points and core switching nodes. In traditional fixed and mobile networks, monitoring equipment would be configured to tap specific links, such as T-1/E-1 interfaces, to capture data. As the networks evolve toward IP-based technology, the fixed and mobile networks may share the same links.

The identity of network subscribers may change depending upon the interface carrying subscriber data. The subscriber identity may be represented in data packets as an IP address, session ID, or temporary ID that is assigned by the access network or the core network. A mapping function is typically used to map the identities of a subscriber across different interfaces or networks. A subscriber or group of subscribers, such as subscribers operating under the same company account, may be identified as a High Value Account (HVA) for network monitoring purposes.

Subscriber devices, such particular mobile devices, PDAs, or user equipment, may be designated as belong to a High Value Group (HVG). For example, mobile devices of the same model or manufacturer, having a specific capability, or using a particular operating system may be classified as an HVG for network monitoring purposes. An International Mobile Equipment Identity (IMEI) assigned to the mobile device may be used to group or classify device as belonging to a particular HVG.

Subscribers or devices within a particular area may be identified as belonging to a High Value Region (HVR). Users covered by a particular cell, group of cells, access point, or sector may be identified as belonging to the HVR for monitoring purposes. For example, subscribers at a concert or sporting event may be assigned to an HVR for monitoring purposes. The networks supporting subscribers in area are likely to have a spike in data traffic use around the time of the concert or sporting event.

After identifying high value accounts, groups or regions, the network monitoring system may collect data for the high value subscribers to analyze, for example, who is in the group, what type of services are being used, what type of data is being uploaded or downloaded and what type devices are being used. The correlated group information may be sent to a network engineering and planning to evaluate network performance.

Although the term “high value” is used in the present disclosure, it will be understood to refer merely to a specific group, account or region without requiring any specific quality or financial or other value. The high value account or group may include low quality devices. For example, a “cheap” mobile device, such as a handset having poor quality components or software, may be designated as a HVG. The cheap mobile device may not work properly in particular networks. All units of the mobile device would be identified with the same IMEI by the manufacturer. This IMEI could be designated as a high value group. Data packets detected in the networks associated with this IMEI would be associated by the monitoring system with the particular high value group. The network operator could then apply rules to deal with the mobile devices in this high value group, such as blocking voice or data calls or lowering the quality of service or priority for those devices.

High value groups may be used to identify subscribers from one network who appear on another network. For example, a mobile device may have the capability to communicate over both a wireless network, such as a GSM or UTRAN network, and a fixed network, such as a residential DSL network using a Femtocell or other access point. When communicating via the fixed network, voice and data packets from the mobile device may be routed to the wireless network for processing. These devices could be designated as a high value group by the fixed network, which would allow for monitoring of the devices impact on the fixed network.

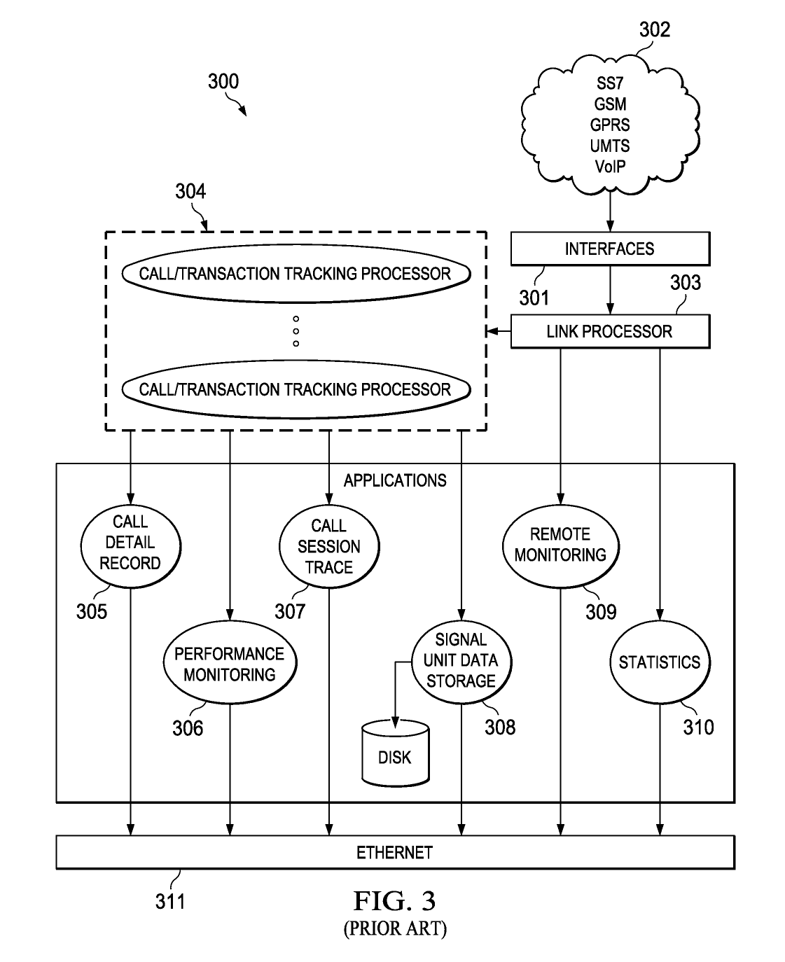

FIG. 3 illustrates the data flow in one embodiment of an existing network monitoring framework. Interfaces 301 are coupled to configured links in network 302 and process data captured on all the links. Data from interfaces 301 is fed to link processor 303, which begins mapping by identifying packets as user data or control data. Control packets are routed to Call/Transaction Tracking Processor (CTTP) 304, which binds together request and response messages for each subscriber. Data from CTTP 304 is provided to a number of applications, including call detail record application 305, performance monitoring application 306, call session trace application 307, and signal unit data storage 308. Data from link processor 303 is also provided to Remote Monitoring (ReMon) protocol analysis application 309 and statistics application 310. Data from these applications may be provided to other applications or devices for further processing via network 311.

The passive monitoring solution framework of FIG. 3 looks at every packet captured from networks 302. When the bandwidth per subscriber is increased due to high bandwidth applications and services, numerous fast microprocessors and processor blades are required by framework 300 to process the data. Such a system is neither cost effective nor efficient for high bandwidth applications since many of the packet will be associated with user plane data or subscribers that are of little interest. Furthermore, storing all of the captured high bandwidth data would require terra bytes of storage space. Such massive storage requirements pose additional challenges such as disk access and retrieval times to write and retrieve the data.

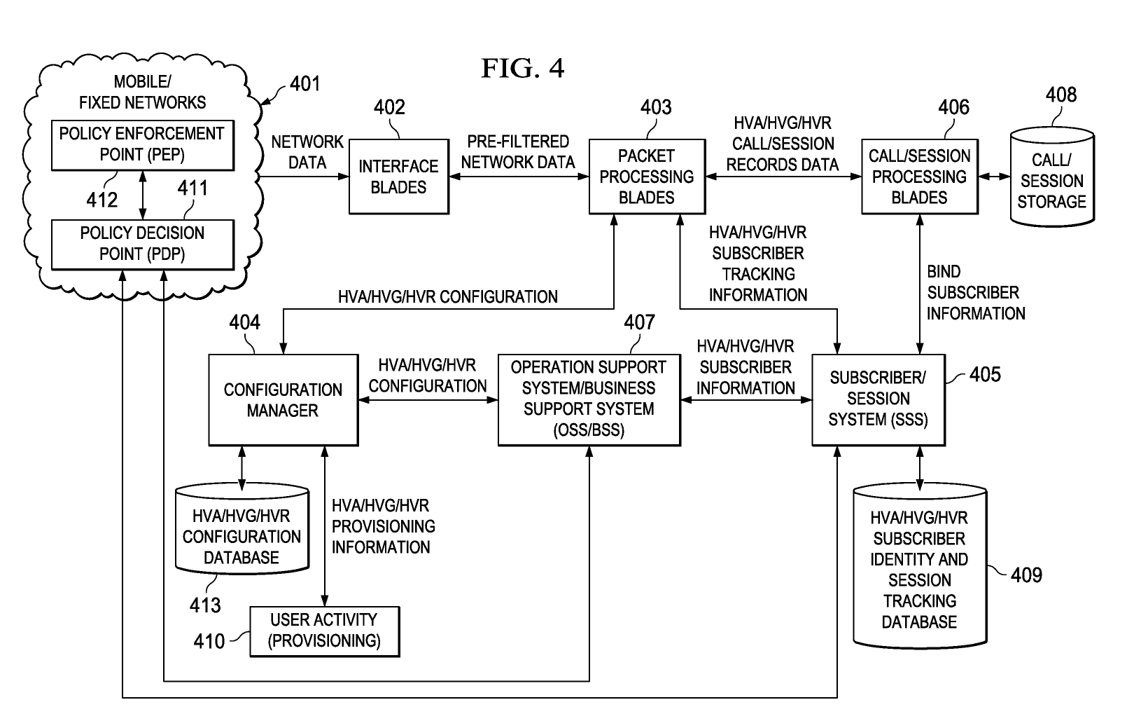

FIG. 4 illustrates one embodiment of a high level framework for processing high bandwidth signaling and data. Embodiments of the present invention correlate all the data packets for a group of subscribers so that a user can review all the packets for the group. Call or session records comprise matched request and response packets for a transaction. The bound request and response packets are stored as Call Detail Records (CDR), which are correlated to a particular subscriber, equipment type or group. The packets and CDRs can be stored in databases. A call session trace can be performed on the CDRs to identify additional call information, such as, for example, dialed digits, call length, and success or failure of the transaction.

The key entities in the system illustrated in FIG. 4 are Subscriber/Session System (SSS) 405, configuration manager 404, interface blades or board 402, packet processing blades or board 403, and call/session processing blades or board 406.

SSS 405 acquires per subscriber and per session information from the Operation Support System/Business Support System (OSS/BSS) 407. Additionally, SSS 405 acquires per subscriber and per session information from the monitoring entities 403, 404, that track, correlate, and process subscriber data and forward the pertinent information to the SSS for storage. The subscriber information stored in SSS 405 may come from multiple probes and multiple interfaces. The SSS is responsible for correlating the subscriber information coming in from multiple entities and storing them as one super subscriber record. SSS 405 performs a mapping function. All subscriber IDs detected on the interface blades, such as UTRAN IDs, IP addresses, or session IDs, are sent to SSS 405, which creates a single super record for each subscriber. As information is provided to SSS 405, the fields of the super subscriber record are filled in. The subscriber records in SSS 405 may be stored in database 409 for long-term storage. The records in SSS 405 are aged so that after a record has been idle (i.e. not updated) for a preselected time, then the record is stored to database 409. The records in database 409 can be recalled, if necessary, to review past network activity.

Configuration manager 404 obtains HVA/HVG/HVR provisioning information from either a user configuration profile or from the OSS system. The configuration information is stored persistently in the configuration manager database. The configuration information is downloaded to the respective probing systems 403 to process only high value signaling and data.

Interface blades 402 receive the data from the mobile and fixed networks 401 by passively monitoring the network interfaces. Interface blades 402 apply pre-filtering before forwarding the data to packet processing blades. The pre-filtering filters include, for example, IP addresses, ports, and applications.

Packet Processing Blades (PPB) 403 are responsible for binding a packet to a HVA/HVG/HVR subscriber. If a packet does not meet the HVA/HVG/HVR criteria, then, based on the network operator's configuration, the packet will be either forwarded to protocol analysis tool or discarded. If subscriber information is not present, packet blades 403 obtain the information from SSS 405.

Call/Session Processing Blades 406 are responsible for correlating packets and present updated subscriber information to the SSS.

Data packets are captured from links in mobile/fixed networks 401 using interface blades 402. Typically, mobile/fixed networks 401 are high bandwidth networks supporting multiple service providers, protocols and applications. Interface blades 402 are processor-based devices that passively capture and pre-filter the data packets. The interface blades 402 output correlated data packets that have been associated with a particular subscriber and a physical or logical link in networks 401. The data rate of the input to interface boards 402 corresponds to the speed of the monitored links, which may be 10+ Gbps. After processing and correlation, the pre-filtered data output from interface blades 402 to packet processing blades 403 has a significantly reduced data rate.

Packet processing blades 403 receive the pre-filtered data from interface blades 402. Packet processing blades 403 bind the pre-filtered data packets to a particular HVA/HVG/HVR subscriber and create HVA/HVG/HVR call/session records. Configuration manager 404 provides HVA/HVG/HVR configuration information to packet processing blades 403, and SSS 405 provides HVA/HVG/HVR subscriber data.

Call/session processing blades 406 aggregate the data packets into a flow session record per selected time period. Call session processing blades 406 extract the important data from the call/session records and creates a smaller record of the flow data. The flow session records are stored in database 408.

TABLE 1 illustrates the fields of a super subscriber record according to one embodiment. SSS 405 starts a new super subscriber record upon receiving a new subscriber ID or IP address that does not belong to any other super subscriber record. The fields of the super subscriber record are not all available in any one data packet, but are spread out among different types of packets. As SSS 405 receives additional packets associated with this subscriber/IP address, SSS 405 fills in the missing data in the super subscriber record.

TABLE 1

IP Address
IMSI
IMEI/Software version
MSISDN
PTIMSI
TILI
Location/Cell ID
HV group ID
GPRS Tunnel ID
Ciphering Keys
Mobile Station IP Address
Mobile Station Application ID
from User Agent Profile

In one embodiment, HTTP packets may be used to create a super subscriber record for a mobile device on network 401. To bind a subscriber to a HTTP packet at packet processing blade 403, the SSS 405 fetches data from OSS/BSS 407 about the subscriber's current IP Address, IMSI, and MSISDN. Alternatively, this data can be detected through subscriber tracking across multiple interfaces. Interface blades 402 monitor multiple interfaces, including Radius, DHCP, and GTP interfaces. As the packets from those interfaces are processed, the information is correlated to create a super subscriber record that is used at the packet processing module to identify and tag the packet with right subscriber information.

OSS/BSS 407 allows the service provider or network operator to provide information regarding HVA/HVG/HVR terminals, equipment, subscribers, or cells. The OSS system 407 is responsible forwarding HVA/HVG/HVR configuration and HVA/HVG/HVR subscriber information. The forwarding process may be a push upon detection of respective triggers. OSS/BSS 407 identifies what account, groups or regions the SSS mapper should use to sort the captured network data. For example, a network operator may define an HVA by providing a list of subscribers associated with a particular account, such as by identifying a SIM card or user equipment, subscriber, or call identifier of interest. OSS/BSS 407 provides that subscriber list to SSS 405 to begin tracking the HVA. The user may request tracking of a designated subscriber, group or region. SSS 405 correlates the subscriber ID to user equipment phone number, network nodes or interfaces, and reports back to OSS/BSS 407 in real-time.

The configuration manager 404 is used with SSS 405 and OSS/BSS 407. OSS/BSS 407 provides a list of high value groups/accounts/regions and provides policy rules for the group to configuration manager 404. The configuration manager 404 then configures packet processing blades 403 on how to process the data for the group by downloading rules. Configuration manager 404 identifies the relevant parameter to identify the high value group, such as by identifying a particular node, interface or user equipment, and instructs packet processing blades 403 what to do with the high value group, such as tagging packets, notifying a user, or performing a call trace. Packet processing blades 403 may add a high value tag to packets as they are processed. For example, a particular mobile device number may be designated as belonging to a high value account or group. For each subsequent packet that s packet processing blades 403 detect with that mobile. By tagging the packets prior to storage, they are easier to find and retrieve in later queries. Configuration manager 404 may be configured by a user 410 and/or may use stored policies in database 413.

In one embodiment, interface blades 402, packet processing blades 403, call/session processing blades 406 and call/session storage 408 are components of a network monitoring or probing system that is used to analyze the performance and operation of mobile/fixed networks 401. Configuration manager 404, SSS 405, user activity provisioning 410, subscriber database 409 and HVA/HVG/HVR configuration database 413 may also be part of the network monitoring system, or part of a separate system that operates in cooperation with the network monitoring system. OSS/BSS 407 may be part of the network monitoring or probing system, or may be a separate system that provides an interface to PDP 411.

Policy Decision Point (PDP) 411 contains rule sets that are used by Policy Enforcement Point (PEP) 412 to prioritize enforcement policies for data packets in network 401. OSS/BSS 407 provides policies to PDP 411 that determine how data packets are enforced. PDP 411 includes policy rule sets that control how packets are enforced. For example, if processing capability drops below a certain level, such as 90% of peak capacity, then PDP 411 will cause PEP 412 to instruct packet processing blades 402 to start dropping packets. In one embodiment, PDP 411, and PEP 412 are NEMs (network equipment manufacturers) components that are part of mobile/fixed networks 401 that are coupled to OSS/BSS 407 or SSS 405 via standard interfaces, such as a Diameter interface. For example, PDP 411 may be a Policy & Charging Rules Function (PCRF) in the network. PEP 412 may be a GGSN in a UMTS network or a Packet Data Network Gateway (PGW) or Serving Gateway (SGW) in an LTE network. The GGSN, SGW, or PGW (e.g. PEP 412) can shape or drop packets in network 401 to buffer or scale-down bandwidth.

HVA/HVG/HVR data is stored in database 409. SSS 405 sends the HVA/HVG/HVR data to OSS/BSS 407, which then forwards the data to PDP 411. Alternatively, SSS 405 may forward HVA/HVG/HVR data directly to PDP 411 if the network connections support a direct connection.

PDP 411 is used to control the operation of components in mobile/fixed networks 401. This can be used to improve the data flow and traffic management in network 401. For example, a GGSN (e.g. PEP) in network 401 may be limited to a 500 Kbps data rate. A mobile device may set up a tunnel to the GGSN and request a pre-defined QoS. The GGSN has limited information regarding the mobile device. However, the network operator may identify the mobile device as a high value account that is subject to special treatment. In one embodiment, the mobile device is a “rogue” device of poor quality that creates excess load in network 401 due to poor RF communications or frequent dropped packets. The network operator may define the IMEI for such rogue devices as a High Value Group (HVG). The GGSN may not have sufficient data or rules to identify the rogue device as a problem subscriber. However, as packets from the rogue device are captured by interface blades 402 and processed by packet processing blades 403 and call/session processing blades 404, the monitoring system will determine that the rogue mobile is assigned an IMEI for the HVG. Upon recognizing that the mobile device belongs to a HVG, the PDP 411 will apply policies and direct the GGSN (or PEP) whether it should block or allow requests from the rouge mobile.

Additionally, the PDP can be used for traffic management and enforcement. For example, data passing through the GGSN (or PEP) or sent to the rogue mobile may be re-shaped, buffered, delayed or re-prioritized to improve network 401 operations. In this way, the GGSN may initially set up the data tunnel to the rogue mobile using the requested QoS, until the configuration manager determines that the mobile is assigned to an HVG. The PDP 411 applies the designated policies to control the traffic flow in the GGSN or PEP and other nodes of networks 401.

The rogue mobile device is identified when its IMEI is determined to be assigned to an HVG. SSS 405 builds a super subscriber record for each subscriber or device on networks 401. OSS/BSS 407 may define which fields/values in the super subscriber record correspond to a particular high value group. In the example above, OSS/BSS 407 may define a particular IMEI as belonging to a high value group. OSS/BSS 407 may also define PDP for that high value group. Upon detecting the IMEI for the mobile device, the device is identified as belonging to the high value group and the associated PDP are applied to network 401.

In another embodiment, a corporate entity with multiple individual mobile devices and user equipment may be defined as a High Value Account (HVA). A network service provider may enter into a Service Level Agreement (SLA) with the corporate entity that guarantees a minimum data rate for the mobile devices. When the mobile devices and user equipment assigned to the corporate entity's account are detected by the monitoring system, they will be designated as part of the HVA in their respective super subscriber records. The network operator may define PDP to ensure that this group of subscribers receives the minimum data rates agreed to in the SLA.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. A method of monitoring a telecommunications network having a plurality of network nodes coupled by a plurality of links, comprising:
capturing data packets from the links in the telecommunications network via plurality of monitoring probes;
filtering the data packets to classify the data packets by application or subscriber identification and link identification to create classified packets;
filtering the classified packets by application to create call session records;
creating a subscriber record, the subscriber record binding subscriber information from the call session records, the subscriber record comprising a plurality of fields including a high value tag;
defining policy rules corresponding to the high value tag; and
controlling one or more of the network nodes according to the policy rules.

2. The method of claim 1, wherein the high value tag associates the subscriber record with a particular account, group or region.

3. The method of claim 1, wherein the policy rules define a quality of service for subscribers associated with a particular high value tag.

4. The method of claim 1, wherein an interface board or packet processing board filters the data packets to classify the data packets by subscriber identification and link identification and to create classified packets.

5. The method of claim 1, wherein packet processing blades are used to filter the classified packets by application to create call session records.

6. The method of claim 1, wherein a subscriber session system creates the subscriber record.

7. The method of claim 1, wherein a policy decision point controls one or more of the network nodes according to the policy rules.

8. The method of claim 1, further comprising:
binding the subscriber record with a location tag.

9. The method of claim 1, wherein the subscriber record comprises information collected from multiple links and multiple monitoring probes.

10. A system for monitoring IP flows in a telecommunications network comprising a plurality of network nodes interconnected by a plurality of links, comprising:
a plurality of monitor probes coupled to the links in the telecommunications network, the monitor probes capturing data packets from the links and filtering the data packets to classify the data packets by subscriber identification and link identification to create classified packets;
a packet processor coupled to the monitor probe, the packet processor filtering the classified packets by application to create call session records;
a session processor coupled to the packet processor for correlating packets and providing subscriber information to a subscriber session processor;
the subscriber session processor creating a subscriber record, the subscriber record binding subscriber and comprising a plurality of fields including a high value tag; and
a policy decision point controlling one or more of the network nodes according to policy rules, the policy rules corresponding to the high value tag.

11. The system of claim 10, further comprising:
an operation support system coupled to the configuration manager processor and the subscriber session processor, the operation support system adapted to input the policy rules.

12. The system of claim 10, wherein the subscriber session processor binds subscriber information across multiple links in the network based upon data service analysis.

13. The system of claim 10, wherein the subscriber session processor binds subscriber information across multiple monitor probes.

14. The system of claim 10, wherein the policy rules define quality of service requirements for subscribers associated with the high value tag.

15. A computer program product that includes a computer readable medium useable by a processor, the medium having stored thereon a sequence of instructions which, when executed by the processor, causes the processor to monitor and aggregate packets in a telecommunications network, by:
capturing data packets from links in the telecommunications network via a plurality of monitoring probes;
filtering the data packets, using an interface processor, to classify the data packets by subscriber identification and link identification to create classified packets;
filtering the classified packets by application, using a packet processor, to create call session records;
creating a subscriber record, using a subscriber session processor, the subscriber record binding subscriber information from the call session records, the subscriber record comprising a plurality of fields including a high value tag; and
controlling one or more of the network nodes, using a configuration manager, according to policy rules that correspond to the high value tag.

16. The computer program product of claim 15, wherein the high value tag associates the subscriber record with a particular account, group or region.

17. The computer program product of claim 15, wherein the policy rules define a quality of service for subscribers associated with a particular high value tag.

18. The computer program product of claim 15, wherein a configuration manager controls one or more of the network nodes according to the policy rules.

19. The computer program product of claim 15, further comprising:
binding the subscriber record with a location tag.

20. The computer program product of claim 15, wherein the subscriber record comprises information collected from multiple links and multiple monitoring probes.
